(19) United States
(12) Patent Application Publication
(10) Pub. No.: US 2007/0182832 A1
(43) Pub. Date: Aug. 9, 2007

(54) MEMORY CARD WITH FUNCTION OF VIDEO/AUDIO DATA PROCESSING

(75) Inventors: Wallace Kou, Los Altos, CA (US); Yu-Wei Chyan, Hsinchu (TW)

Correspondence Address: PAI PATENT & TRADEMARK LAW FIRM, 1001 FOURTH AVENUE, SUITE 3200, SEATTLE, WA, 98154, US

(73) Assignee: SILICONMOTION INC., Jhubei City (TW)

(21) Appl. No.: 11/382,477

(22) Filed: May 9, 2006

(30) Foreign Application Priority Data
Feb. 8, 2006 (TW) 95104267

(51) Int. Cl. H04N 5/76

(52) U.S. Cl. 348/231.9

(57) ABSTRACT

A memory card with the function of video or audio data processing includes a card controller and a memory for storing encoded video/audio data. The card controller includes a card microprocessor, a buffer and a video/audio data processor. The card microprocessor controls internal and external data access. The buffer is for temporarily storing data during data processing. The video/audio data processor is adapted for coding raw data from an external host system or decoding coded data stored in the memory.

### RELATED APPLICATIONS

The present application is based on, and claims priority from, Taiwan Application Ser. No. 95104267, filed Feb. 8, 2006, the disclosure of which is hereby incorporated by reference herein in its entirety.

### BACKGROUND OF THE INVENTION

1. Field of Invention

The invention relates to a memory card and, in particular, to a memory card with video/audio data coding/decoding functions.

2. Related Art

Due to increasing personal messages and recorded data as well as the popularity of portable information devices, such devices as mobile phones, personal digital assistants (PDA) and digital cameras have become important memory devices for personal messages and recorded data. Generally speaking, storage space on portable devices is not very large. Such a capacity does not satisfy the huge message and data amount needed by the user.

Memory cards, such as the multi media card (MMC) or secure digital (SD) memory card, are a type of external memory devices developed to store data for the access of digital cameras, smart phones, etc.

However, the primary purpose of memory card devices is to store general data. To access data, the memory card has to be connected with a host system. The processing unit of the host system sends out a command for accessing the memory card. When the data stored in the memory card are video/audio related files in special format, such as MP3, AAC, and WMA for audio files and MPG for video files, the host system has to retrieve these files in the usual way and store them in itself for decoding.

For example, a primary processor with better efficiency or another application specific decoding chip is employed for decoding. The video/audio file after decoding turns into a file in a standard format for playing. The files are output via speakers/monitor using a digital-to-analog converter (DAC).

Therefore, because of their compactness, some host systems such as mobile phones have limited capability in their internal data processing units and thus cannot perform decoding. Therefore, a processing unit of application-specific decoder with more powerful functions but occupying a larger area has to be re-designed. To perform decoding in the host system, a larger buffer space is also required.

### SUMMARY OF THE INVENTION

An objective of the invention is to provide a memory with the function of video/audio data processing so that the special video/audio files can be directly decoded inside the memory card for reducing the burden of the host system.

Another objective of the invention is to provide a memory with the function of video/audio data processing for increasing the value of low-efficiency electronic devices.

A further objective of the invention is to provide a memory with the function of video/audio data processing that not only stores general data but also has the coding/decoding function.

In accord with the above objectives, the disclosed memory card with the function of video/audio data processing includes a memory and a memory card controller. The memory card controller performs internal data access with the memory through an internal memory interface and external data access with an external host system through an external interface of the memory card. The memory card controller includes a buffer, a memory card microprocessor, and a video/audio data processor.

In an embodiment of the invention, the video/audio data processor is a video/audio decoder. The memory is used to store encoded video/audio data. The buffer is used to temporarily hold the video/audio data during the data transmissions. The memory card microprocessor controls the internal data access, temporarily storing or extracting the video/audio data. The video/audio decoder is used to decode the video/audio data.

When the video/audio data are temporarily stored in the buffer, the video/audio decoder decodes the video/audio data in the buffer into decoded data and stores them in the buffer. The memory card controller sends the decoded data to an external host system.

According to another embodiment of the invention, the video/audio data processor in the memory card is a video/audio decoder so that the memory card has the function of video/audio processing. When the buffer temporarily stores original digital data, the video/audio decoder encodes the original digital data in the buffer, forming an encoded file, and stores it in the memory.

According to yet another embodiment of the invention, the video/audio data processor is a video/audio decoder with the functions of both coding and decoding. When it performs decoding, the video/audio data in the memory are controlled by the memory card microprocessor to be temporarily stored in the buffer. The video/audio decoder decodes the video/audio data in the buffer into decoded data. The decoded data are then temporarily stored in the buffer. The memory card controller sends the decoded data to a host system for playing.

When it performs coding, the buffer temporarily stores the original digital data from the external host system. The video/audio coder encodes the original digital data in the buffer, forming an encoded file, and stores it in the memory.

The video/audio data processor can be, for example, an application-specific digital signal processor as a coder/decoder (CODEC) for executing coding or decoding. The coding or decoding function can be designed to be executed by the memory card microprocessor. As long as the processing power of the microprocessor can execute the coding or decoding function, the memory card microprocessor is also a video/audio data processor.

The invention is applicable to conventional electronic devices with the video or audio playing function. The coding or decoding function of the memory can be executed by simply loading in software. The video/audio data in specifically coded format become playable video/audio data in the normal standard after decoding. Therefore, the usual low-level electronic devices can play or record video/audio files in special formats.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1A shows a preferred embodiment of the memory card with the function of video/audio data processing in accord with the invention;

FIG. 1B shows another embodiment of the decoding device of the memory card with the function of video/audio data processing in accord with the invention;

FIG. 2A is a flowchart of decoding by the memory card with the function of video/audio data processing in accord with the invention; and

FIG. 2B is a flowchart of coding by the memory card with the function of video/audio data processing in accord with the invention.

### DETAILED DESCRIPTION OF THE INVENTION

The present invention will be apparent from the following detailed description, which proceeds with reference to the accompanying drawings, wherein the same references relate to the same elements.

The invention discloses a memory card with the function of video/audio data processing, so that the coding/decoding of files in special video/audio data formats is directly executed by the memory card. There is not need to re-design the data processing unit of the host system or to add an application-specific CODEC therein. The video/audio data processing here refers to the action of coding or decoding video/audio data. Please refer to the following description along with the accompanying drawings for an explanation of the invention.

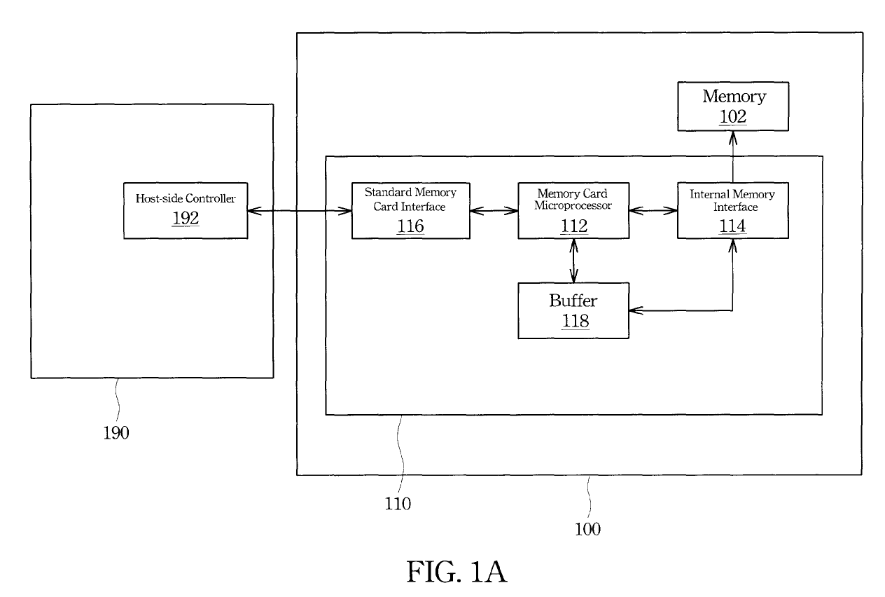

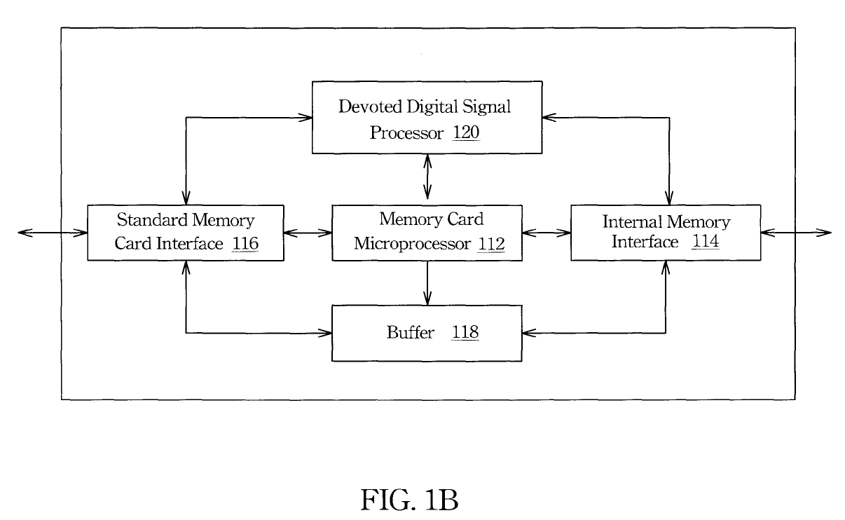

With reference to FIG. 1, a preferred embodiment of the disclosed memory card 100 includes a memory 102 and a memory card controller 110. The memory card controller 110 includes a memory card microprocessor 112, a buffer 118, and a video/audio data processor.

The memory 102 is used to store coded files produced from coding jobs or video/audio files assigned in decoding jobs. The video/audio data processor has the function of coding, decoding, or both coding and decoding.

The memory card controller 110 performs internal data access to the memory 102 via an internal memory interface 114 and external data access to a host system 190 via an external interface 116 of the memory card, such as a memory card. The above-mentioned data access is controlled by the memory card microprocessor 112. The buffer 118 is used to temporarily hold data during video/audio data processing.

In a preferred embodiment, the memory card is a flash memory card whose interface can be the usual standard interface, such as the SD card interface. When the memory card is inserted into a host system (i.e., the connection between the memory card 100 and the host system 190 is established), the host system 190 sends a request command to the memory card 100, which can simultaneously identify memory card and initiate its coding or decoding function. The host system 190 is an electronic device (e.g., mobile phone) with the function of video/audio playing or recording.

For the usual data access function, the disclosed memory card 100 with the function of processing video/audio data involves basically the same procedure as normal disk drives. When it accesses the data in the memory card, the internal data are transmitted via the internal memory interface 114, the buffer 118, and finally the memory card external interface 116 outside the memory card.

When files are stored to the memory card, the external data are transmitted via the memory card external interface 116, the buffer 118, and the internal memory interface, and finally written into the memory 102. The above procedure is controlled by the memory card microprocessor 112.

After the memory card with the function of video/audio processing starts its function of video/audio coding or decoding, the host system 190 only provides a data transmission channel in addition to sending a command to the memory card 100 to request file transmissions. That is, the video/audio data decoded by the memory card 100 are transmitted to a rear-end device (not shown) via the host system 190 for playing. The rear-end device is an analog-to-digital converter (ADC) and a speaker or screen. Alternatively, the original digital data produced by the front-end device are transmitted via the host system 190 to the memory card 100 for the memory card 100 to code and store.

The action of video/audio coding or decoding is processed by the memory card, thereby reducing the burden of the host system. These front-, rear-end devices can be integrated in the host system 190 or connected to the host system 190, depending on the design of the host system 190.

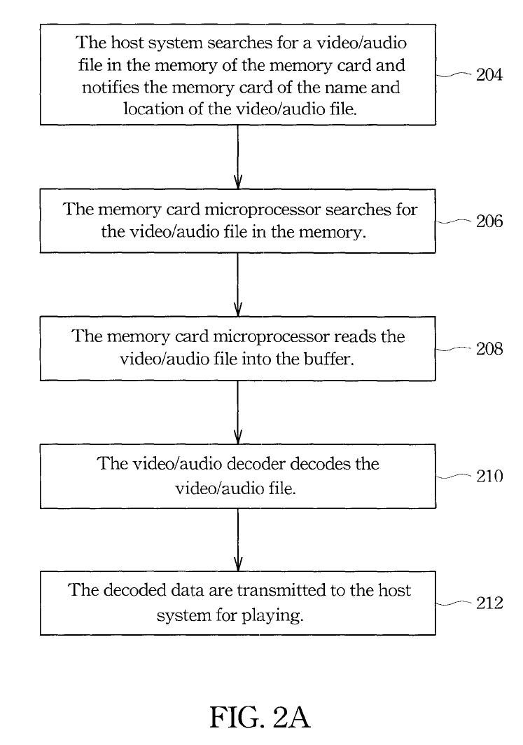

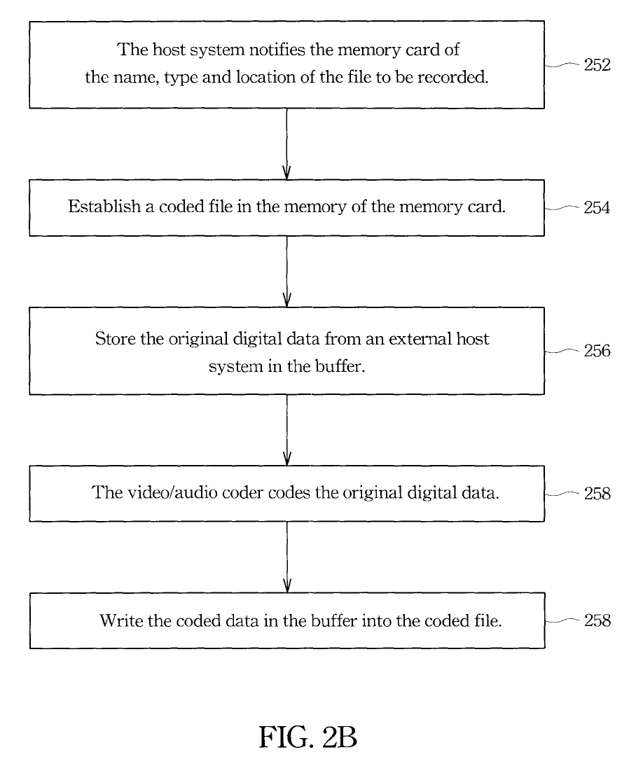

With simultaneous reference to FIG. 2A, an embodiment is used to illustrate the procedure of decoding by the memory card. After the video/audio decoding function starts, the host-side controller 192 first reads the file system in the memory 102 in the same way as reading normal data in step 204. It looks for video/audio files to be played from the contents of the file system. Such files have specific file formats, such as MP3 and AAC.

Once the assigned video/audio files are found, the host-side controller 192 sends out a specific decoding command via the memory card external interface 116, notifying the memory card 100 of the file names and their locations.

In step 206, after receiving the specific decoding command, the memory card microprocessor 112 searches for video/audio files inside the memory 102 via the interface memory interface 114. In step 208, after the memory card microprocessor 112 finds the assigned video/audio files, the files are read into the buffer 118. In step 210, the memory card microprocessor 112 decodes the video/audio files, producing decoded data. They are in the form of original digital data and stored in the buffer 118.

In step 212, the memory card controller 110 sends out the decoded data in the buffer 118 via the memory card external interface 116 to the host-side controller 192 of the host system 190.

As shown in FIG. 2B, video/audio data recording is used as an example to explain the coding function of the memory card. In step 252, the host-side controller 192 first notify the memory card 100 of the file names, types, and locations to be recorded via the memory card external interface 116. In step 254, after the memory card microprocessor 112 of the memory card 100 receives the coding request command, it establishes a coded file in the memory 102 via the internal memory interface 114. At this moment, the file has a file name but no actual contents.

In step 256, the host-side controller 192 transmits a set of original digital data to the buffer 118 via the memory card external interface 116. The original digital data are produced from the analog-to-digital converting process done in the host system 190. In step 258, the memory card microprocessor 112 or a devoted digital signal processor 120 codes the original digital data in the buffer 118, forming the designated file format that is still stored in the buffer 118.

In step 260, the memory card controller 110 writes the coded data in the buffer into the coded file.

It should be noted that the above embodiment uses a single coding or decoding function as an example to explain the invention. The corresponding devoted digital signal processor is a coder or decoder. However, the invention can be an integrated device with both coding and decoding functions, analogous to a coder/decoder (CODEC).

FIG. 1B shows another embodiment of the memory card decoder with the function of video/audio data processing. Although the above-mentioned embodiment uses the microprocessor inside the memory card to do the coding or decoding job, an additional devoted digital signal processor 120 may be used to achieve the same effects, particularly in decoding.

The coding and decoding of video/audio data require a processor with a sufficient efficiency. If the memory card microprocessor of the memory card is a high-performance 16- or 32-bit microprocessor, it is competent in decoding digital signals. However, if the memory card microprocessor is designed for processing usual data access, then an additional digital signal processor is needed as the decoder.

As shown in the drawing, if data in the memory card need to be coded or decoded, they are processed using the devoted digital signal processor 120, which functions as a coder or decoder. Such a job is no longer transferred to the memory card microprocessor 112. This can enhance the efficiency or reduce the burden of the memory card microprocessor 112.

In accord with the descriptions of the above embodiments, the invention has at least the following advantages. The invention enables cheap electronic devices, such as cell phones, to play video/audio files coded in specific formats. Since the cost of the memory card controller is comparatively lower than the cost of a usual host system controller, the disclosed memory card provides a low-cost solution for the host system.

While the invention has been described by way of example and in terms of the preferred embodiment, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A memory card with the function of video/audio data processing, comprising:
a memory for storing a video/audio file; and
a memory card controller for accessing internal data in the memory via an internal memory interface and external data in a host system via a memory card external interface, the memory card controller including:
a buffer for temporarily storing the video/audio file;
a memory card microprocessor for controlling the data access; and
a video/audio decoder for decoding the video/audio file;
wherein when the video/audio file is temporarily stored in the buffer, the video/audio decoder decodes the video/audio file in the buffer into decoded data; the decoded data are temporarily stored in the buffer; and the memory card controller sends out the decoded data to the host system.

2. The memory card of claim 1, wherein the video/audio decoder is a devoted digital signal processor.

3. A memory card with the function of video/audio data processing, comprising:
a memory; and
a memory card controller for accessing internal data in the memory via an internal memory interface and external data in a host system via a memory card external interface, the memory card controller including:
a buffer for temporarily storing a set of original digital data;
a memory card microprocessor for controlling the data access; and
a video/audio coder for coding the original digital data;
wherein when the buffer temporarily stores the original digital data from the host system; the video/audio coder codes the original digital data in the buffer to form a coded file to be stored in the memory.

4. The memory card of claim 3, wherein the video/audio coder is a devoted digital signal processor.

5. A memory card with the function of video/audio data processing, comprising:
a memory for storing a video/audio file; and
a memory card controller for accessing internal data in the memory via an internal memory interface and external data in a host system via a memory card external interface, the memory card controller including:
a buffer for temporarily storing the video/audio file or a set of original digital data;
a memory card microprocessor for controlling the data access; and
a video/audio coder/decoder (CODEC) for coding the original digital data or decoding the video/audio file;
wherein when video/audio file is temporarily stored in the buffer, the video/audio decoder decodes the video/audio file in the buffer to form decoded data to be stored in the buffer, and the memory card controller sends the coded data to the host system; when the buffer temporarily stores the original digital data, the video/audio coder codes the original digital data in the buffer to form a coded file to be stored in the memory.

6. The memory card of claim 5, wherein the video/audio coder is a devoted digital signal processor.
